(19) United States
(12) Patent Application Publication
(10) Pub. No.: US 2006/0061230 A1
(43) Pub. Date: Mar. 23, 2006

(54) Drive device provided for operating adjusting devices in motor vehicles

(76) Inventor: Uwe Klippert, Coburg (DE)

Correspondence Address: CHRISTIE, PARKER & HALE, LLP, PO BOX 7068, PASADENA, CA, 91109-7068, US

(21) Appl. No.: 10/533,856

(22) PCT Filed: Nov. 6, 2003
(86) PCT No.: PCT/DE03/03735

§ 371 Date: May 5, 2005

(30) Foreign Application Priority Data
Nov. 7, 2002 (DE) 102 53 071.8

(51) Int. Cl. H02K 7/10; H02K 21/12; H02K 1/22

(52) U.S. Cl. 310/268; 310/75 R; 310/83; 310/156.32

(57) ABSTRACT

A drive device provided for operating adjusting devices in motor vehicles includes an axial-field motor equipped with rotor discs. A gear mechanism is connected to the motor shaft and to a drive element of the adjusting device. The motor shaft is supported on the periphery of the axial-field motor by radial webs that are part of a supporting element. A bearing bush for accommodating the motor shaft is integrated inside the body of the supporting element.

### CROSS-REFERENCE TO A RELATED APPLICATION

This application is a National Phase Patent Application of International Application Number PCT/DE2003/003735, filed on Nov. 6, 2003, which claims priority of German Patent Application Number 102 53 071.8, filed on Nov. 7, 2002.

### BACKGROUND

The invention relates to a drive device for adjusting devices in motor vehicles.

From the International Patent Application No. PCT/EP00/01093 (Publication No. WO 00/48294) an electric machine is known designed as an axial field motor or generator and having a rotor mounted rotatable in a housing and a rotor shaft which extends out from the housing. A number of electromagnet structural elements are mounted locally fixed in the housing spaced out at regular angular spaces from the rotational axis of the rotor shaft and each having a coil core supporting a coil winding of one or more wires. The pole faces of the end sides of the coil cores are aligned towards the pole faces of permanent magnets which are mounted rotationally secured in or on the rotor and which each have an opposite polarity circumferentially in succession. The coil cores of the electromagnet structural elements are arranged parallel to the axis of rotation of the rotor shaft inside the housing so that their opposite end sides each lie in two planes spaced from each other and running at right angles to the rotational axis of the rotor shafts.

The connection between the disc-shaped rotors and the rotor shaft and their bearing in the housing of the electric machine means that for testing and actuation the rotors and the stator have to be arranged or mounted completely in the housing. The support and bearing of the rotor shaft on two housing sides however requires an exact precision between the distance of the support points on the housing and the vertical structure of the stator and disc-shaped rotors since owing to the axial support of the rotor shaft there is the risk of over specifying the bearing and consequently high friction losses.

A further problem exists in observing the two very important air gaps in respect of the rotor discs. This coordination requires accurate measuring for example by using close-fitting discs if several parts are arranged between the rotor discs whose tolerances have to be taken into consideration.

### SUMMARY

The object of the invention is to provide a drive device of an axial field motor and a gear mechanism in which the axial field motor can also function without the motor housing and can be pre-checked for its main properties, wherein its construction avoids over specifying and thus high friction losses or expensive dimensioning, requires no precision measuring to observe the air gaps relative to the rotor discs and which enables a connection with a self-locking or non-self locking gearing, and which allows a flat space-saving method of construction.

The solution according to the invention provides an axial field motor which can also run without a motor housing and can thus be pre-checked for its essential properties and whose structural design eliminates over-specifying and thus high friction losses or an expensive oversizing. Since the radial forces which stem from the motor shaft are introduced into the housing of the drive device or axial field motor through axially extending positive locking regions of radial webs, no parts are required in the axial direction with their tolerances for mounting the motor shaft so that there is no need for measuring with thin close fitting discs or the like. Observing the air gaps depends by way of example only on coordinating the motor shaft and a bearing bush supported on the periphery of the axial field motor to hold the motor shaft. The method of constructing the axial field motor enables a connection with different geometrical shapes and by incorporating self-locking properties into the axial field motor also a connection with self-locking or non-self locking gear mechanisms.

The integration of the motor shaft into the axial field motor also enables an extremely flat structure as well as by connecting the gear mechanism to the axial field motor a very compact structural form of drive device.

The design according to the invention for mounting the motor shaft produces with its support on the peripheral side with webs pointing like rays towards the centre of the axial field motor a virtual motor axle so that no axial support of the motor shaft is required and thus no part is played by the vertical structure of the function parts of the axial field motor. This not only eliminates the risk of over-specifying which leads to considerable friction losses or very high accuracy demands with very narrow tolerances, but the axial field motor is also fully functional without a housing and can therefore be pre-tested and adjusted in this state.

The radial webs are preferably supported on the periphery of the axial field motor and have radially directed end ribs which are connectable in the axial direction to the housing of the axial field motor or the drive device in that they engage preferably in positive locking elements of the housing.

Furthermore axially extending positive locking regions of the radial webs can engage in recesses in the housing.

In order to form the virtual axle and support of the motor shaft on the periphery of the axial field motor the radial webs are designed as part of a support element and protrude from a base body holding the motor shaft. Through this configuration of the motor shaft bearing the support body can be inserted into a drive housing through the circumferentially spread out radially aligned end ribs which protrude from the base body of the support element whereby the functional capacity of the axial field motor does not however depend on the connection with a drive housing.

A bearing bush integrated in the base body of the support element for holding the motor shaft can either be formed as part of the base body of the support element or can be inserted in a corresponding socket of the base body of the support element. In the second variation a free-standing external collar of the bearing bush adjoining an end face of the support element serves to fix the position of the bearing bush inside the support element.

The support element is preferably part of the stator of the axial field motor, i.e. by integrating electromagnetic structural elements into the support element it widens the function of the support element beyond a static function so that both the number of parts and also the manufacturing costs are reduced.

The connection of the support element and thus stator to a housing of the axial field motor or a housing which accommodates both the axial field motor and the gear mechanism of the drive device is provided by the radially aligned end ribs of the radial webs which are preferably supported elastically on the housing of the axial field motor or drive device. Between the radially aligned end ribs and the housing of the axial field motor or drive device it is possible to mount a ring which is elastic at least in the axial direction to take up the tolerances of the two housing halves of a two-part housing and to enable an axially play-free mounting.

In order to form the axial field motor the motor shaft is connected to at least one rotor disc which is mounted on an end face of the stator whilst the other end face of the stator forms a magnetic short-circuit. The motor shaft is however preferably connected to rotor discs which are mounted on both end faces of the stator and on which are mounted permanent magnets which face the stator and have circumferentially alternating polarity.

On the output side the motor shaft is connected to a pinion of the gear mechanism formed as a spur wheel gear of the drive device. The spur wheel gear has a toothed wheel of a first gear stage meshing with the pinion and connected coaxially to a second pinion pf a second gear stage which meshes with a second gear wheel connected to the drive element of the adjusting device.

The drive device is preferably mounted in a twin-shelled housing whose one housing shell is connected through the elastic ring to the radially directed end ribs of the support element. The housing shell having the elastic ring furthermore has fixings through which the drive device can be connected to a holding device.

Overall the drive device according to the invention is characterised as a result of the special structural features of the axial field motor through a simple assembly which permits large tolerances of the individual component parts, in which no consideration has to be made for a possible tensioning of the axial field motor. In addition to the low friction losses which result the drive device is characterised by the absence of any troublesome noises.

### BRIEF DESCRIPTION OF THE DRAWINGS

The invention will now be described in further detail with reference to an embodiment illustrated in the drawings.

FIG. 1 is a longitudinal sectional view through the drive device according to the invention with an axial field motor and a spur wheel gear.

FIG. 2 is an exploded view of the axial field motor with a stator, two rotor discs, a bearing bush for holding the motor shaft and a coil spring brake.

FIG. 3 is a diagrammatic perspective view of the support element with a coil body which is to be used.

FIG. 4 is a diagrammatic perspective view of the support element in an alternative embodiment with axially aligned positive locking elements and a diagrammatically illustrated counter positive locking element on the housing side.

FIG. 5 is a plan view of the support element.

FIG. 6 is a first perspective view of the drive device with axial field motor and spur wheel gear and a cable winding roller of a cable window lifter.

FIG. 7 is a further perspective view of the drive device with axial field motor and spur wheel gear and a cable winding roller of a cable window lifter.

FIG. 8 is a plan view of the drive device according to FIGS. 6 and 7.

FIG. 9 is a perspective view of the housing of the drive device with axial field motor and spur wheel gear contained therein.

### DETAILED DESCRIPTION

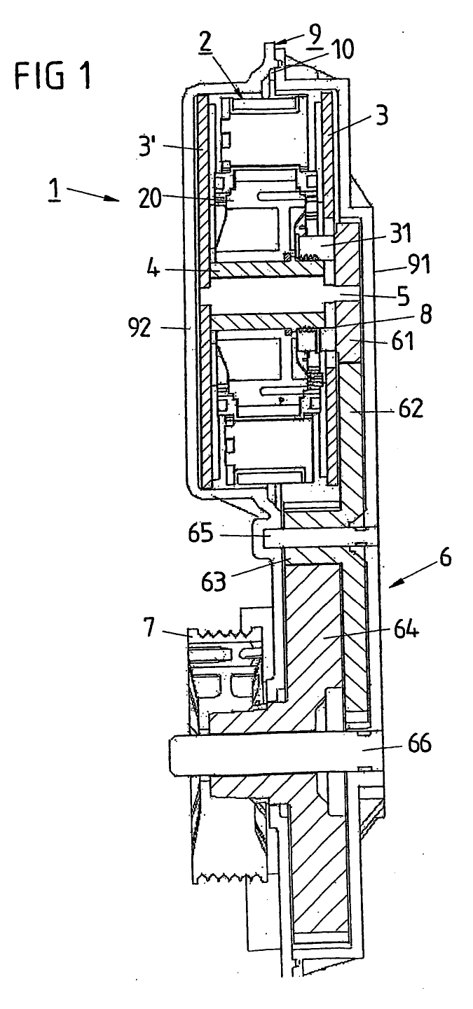

FIG. 1 shows a longitudinal sectional view through a drive device for an adjusting device in a motor vehicle, by way of example for a cable window lifter for lifting and lowering a window pane in a motor vehicle door. The drive device contains in a housing 9 which comprises two housing shells 91, 92 an axial field motor 1 with stator 2 and rotor discs 3, 3′ arranged on the two end sides of the stator 2, a gear mechanism 6 designed as a spur wheel gear, and a drive element of an adjusting device in the form of a cable winding roller 7. As can be seen from the sectional view according to FIG. 1, the drive device is characterised in particular by a flat method of construction which is conditioned through the structural shape of the axial field motor 1 as well as by using a spur wheel gear 6 and the axially boxed construction of the function elements of the drive device. Despite the structure which is kept to a minimum in the axial direction a tension-free design is ensured without over-specifying whose essential features will be explained below.

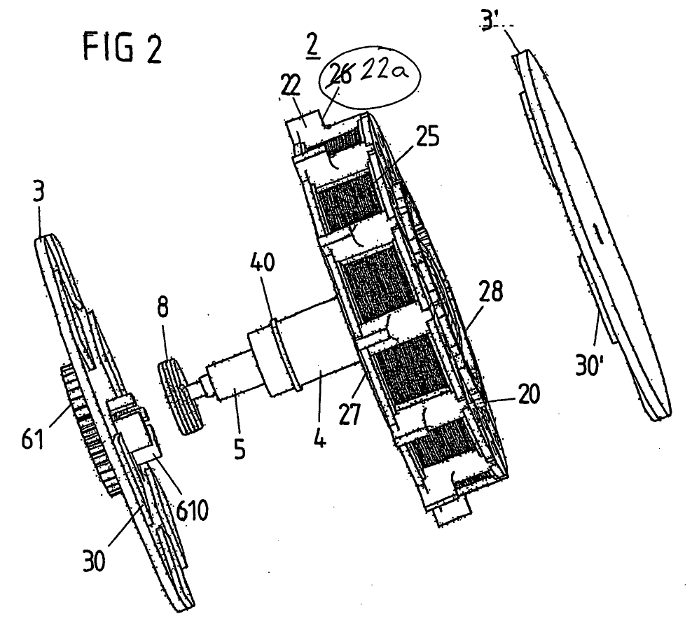

The axial field motor 1 is comprised according to FIGS. 1 and 2 of a stator 2 and two rotor discs 3, 3′ arranged on either side of the end faces 27, 28 of the stator 2. The one rotor disc 3 is connected to a pinion 61 which forms the output of the axial field motor 1 and input of the spur wheel gear 6. The rotor discs 3, 3′ are connected to a motor shaft 5 which is mounted in a bearing bush 4 which is supported not axially but through a star-shaped support element 20 which forms at the same time the mechanical base body of the stator 2 of the axial field motor 1.

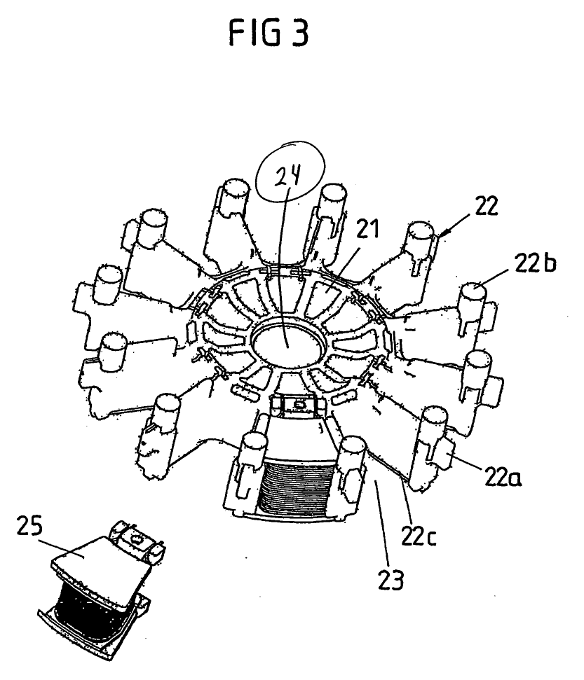

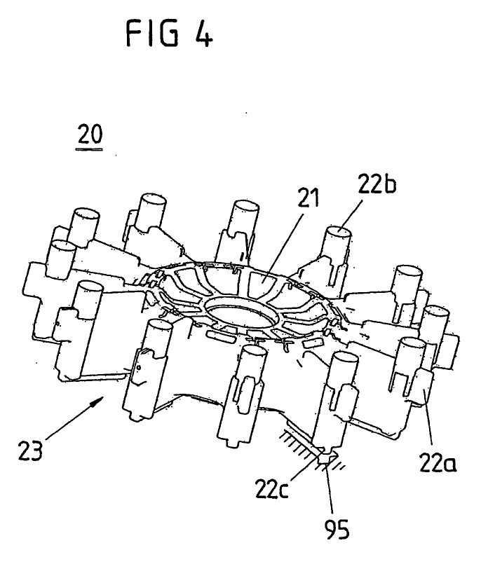

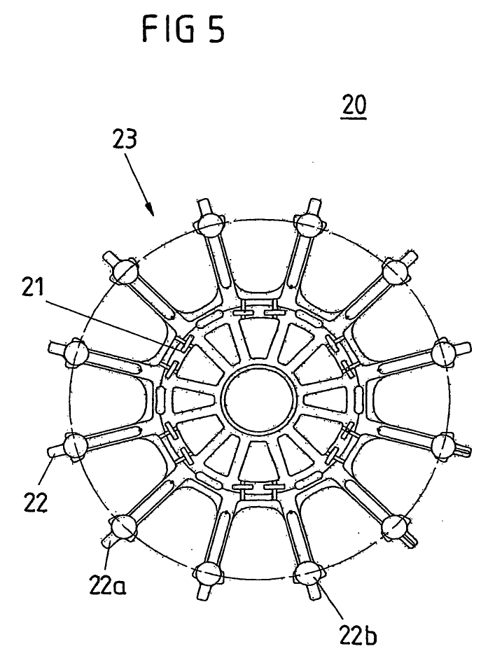

As can be seen from the perspective views of FIGS. 3 and 4 as well as the plan view according to FIG. 5, the support element 20 consists of a base body 21 from which a number of webs 22 protrude radially and between which inserts 23 are formed for holding the coil bodies 25 which each form, through alternating pairs of winding connections, two north poles and two south poles so that each two north poles follow two south poles. The base body 21 has in the center a cylindrical opening or bore 24 which is formed either as a bearing bush for holding the motor shaft 5 or can be mounted onto the one bearing bush 4 according to FIGS. 1 and 2 in which the motor shaft 5 is mounted. For this the bearing bush 4 has a free-standing outer collar 40 which bears against the one end side 27 of the support element 20 and thus fixes the position of the bearing bush 4.

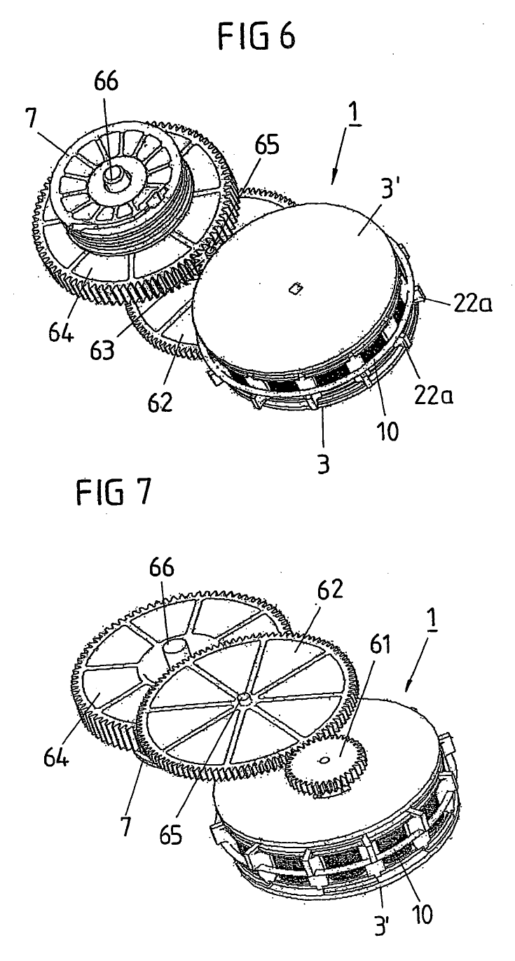

The radial webs 22 have at their outer ends radially directed positive locking elements in the form of radially directed end ribs 22a which preferably engage through an elastic ring 10—as will be explained with reference to FIGS. 6 and 7—in positive locking regions of the housing 9 of the axial field motor or drive device.

Furthermore axially directed positive locking elements are provided in the form of projections 22b and webs 22c which extend over the length of the radial webs 22 and together with the radially directed end ribs 22a introduce the radial forces stemming from the motor shaft 5 into the housing 9.

The counter positive locking elements of the housing 9 are designed accordingly as recesses and take up the motor forces through their stop faces.

Whilst the axially directed projections 22b engage in corresponding recesses in a housing base, the webs 22c are assigned corresponding recesses 95 in the base contour of the housing 9 whose ends are preferably closed for radially guiding the support element 20.

The rotor discs 3, 3′ stand opposite the end sides 27, 28 of the support element 20 whilst forming slight air gaps and have permanent magnets 30, 30′ with circumferentially changing polarity which form the magnetic short-circuit for the magnetic field of the coils of the stator 2.

As can be seen in particular from the sectional view in FIG. 1, the motor shaft 5 is supported solely through the bearing bush 4 and the support element 20 on the periphery of the drive device, i.e. there is no axial support of the motor shaft 5 relative to the housing 9, but only a support over the periphery of the housing 9.

The axial field motor 1 is thus a functioning part independent of the housing 9 of the drive device and whose functions can be tested without the housing 9 and even without the gear mechanism and whose function parts can be corrected or exchanged where applicable. The connection of the axial field motor 1 with the housing 9 of the drive device is through an elastic ring 10 which is fitted according to FIG. 6 on the radially aligned end ribs 22a of the radial webs 22 of the support element 20 and which is supported according to FIG. 1 on the one housing shell 91 of the twin shell housing 9. Through the elastic ring 10 it is possible to compensate tolerances arising in the axial direction in the axial structure of the axial field motor 1 and in the dimensioning of the housing 9 of the drive device and thus to ensure a tension-free fitting taking into account greater tolerances.

In order to avoid counter-effects on the part of the adjusting device driven by the drive device, i.e. to prevent unintended adjustment of the adjusting device in the event of an adjusting torque which is greater than the drive torque of the drive device a brake device is provided which ensures a self-locking of the drive device in the event of a torque of the adjusting device which exceeds the drive torque of the drive device. For this purpose and to provide the flattest possible drive device the double axial field motor shown in FIG. 2 has a brake device in the form of a coil spring brake with a coil spring 8 which is mounted between the rotor disc 3 and a pinion 61 on a gear mechanism provided on the output side and connected to the rotor disc 3 and which bears with pretension against the outside wall of the fixed bearing bush 4 in which the motor shaft 5 is rotatably mounted.

The actuation of the coil spring 8 is through its radially outwardly protruding spring ends which are radially opposite one another. In the rest state or in the current-less state with the onset of torque introduced from the output side the coil spring 8 is actuated by the pinion 61 in both rotational directions through one of its spring ends so that it is firmly clamped at the outer edge of the bearing bush 4. For this according to the perspective view in FIG. 2 projections or shift claws 610 project down from the pinion 61 to each interact with one of the spring ends of the coil spring 8. With the presence of torque on the output side the coil spring brake is hereby locked and a rotational movement is prevented as a result of the clamping action.

The shift claws 610 of the pinion 61 act in the event of torque on the output side for locking the coil spring brake on the ends of the coil spring 12 in order to contract the latter, thus to clamp against the outside wall of the bearing bush 10.

Each of the two spring ends of the coil spring 8 is furthermore assigned a shift region of the rotor disc 3 which releases the coil spring brake, i.e. disengages the coil spring 8 when the axial field motor 2 is energized. The one or other shift region acts on the associated spring end of the coil spring 8 in both rotational directions of the rotor disc 3 in order to lift the spring so far away from the outside wall of the bearing bush 4 that it no longer counteracts the rotational movement and only the smallest possible efficiency losses occur during operation of the axial field motor 2.

Further details for the design and functioning of the coil spring brake can be concluded from the German Patent Application No. 102 36 372.2 to whose contents reference is made.

The gear mechanism of the drive device consists according to FIGS. 1 and 6 to 8 of a spur wheel gear 6 whose first gear stage contains the pinion 61 which is connected to the motor shaft 5 and meshes with a gear wheel 62 mounted on an axis 65. The pinion 63 of a second gear stage of the spur wheel gear 6 which is mounted coaxial with the gear wheel 62 meshes with a gear wheel 64 which rotates about an axis 66 of the second gear stage and which in turn is coupled to the drive element 7 of the adjusting device which is driven by the drive device and in this embodiment consists of a cable winding roller 7 for a cable window lifter.

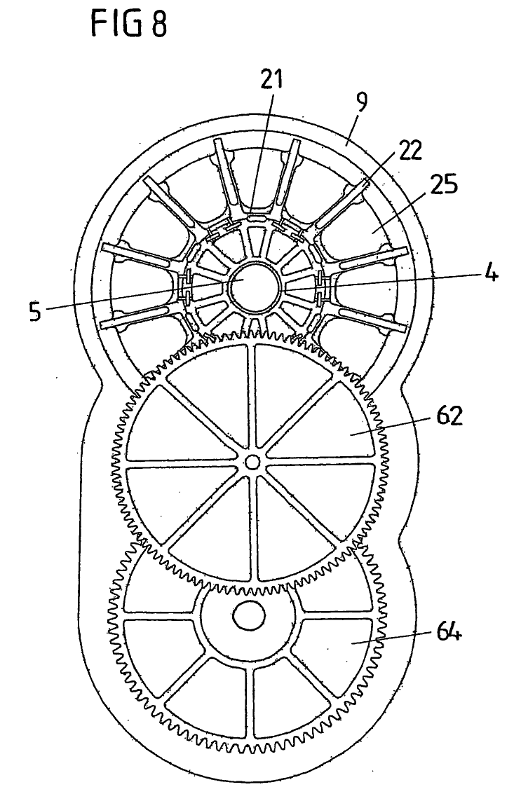

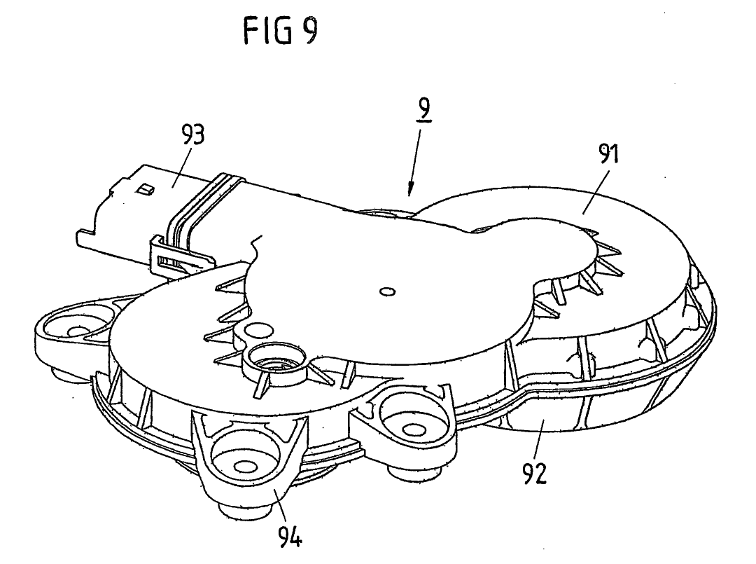

FIGS. 6 and 7 show the different perspective views of the axial field motor and spur wheel gear mechanism. FIG. 8 shows a plan view of the function parts of the drive device contained in the housing 9 whereby this plan view shows the support of the motor shaft 5 on the peripheral side.

FIG. 9 shows in a perspective view the housing 9 which encloses the drive device and which is comprised of two housing shells 91, 92 as described above. The drive device can be electrically connected to a power supply and/or a control or regulating device through a plug connection 93 whilst the mechanical connection between the drive device and holding device is through fixing elements 94 which are mounted on the one housing shell 91.

1. A drive device for adjusting devices in motor vehicles, comprising
an axial field motor having a motor shaft and
a gear mechanism which is connected to the motor shaft and with a drive element of the adjusting device,
wherein radial forces stemming from the motor shaft are introduced into a housing of one of the drive device and the axial field motor through axially extending positive locking regions of radial webs.

2. The drive device according to claim 1, wherein the radial webs are supported on the periphery of the axial field motor.

3. The drive device according to claim 1, wherein the axially extending positive locking regions comprise radially aligned end ribs of the webs which engage in positive locking elements of the housing.

4. The drive device according to claim 3, wherein the radially aligned end ribs of the webs are connected with the housing in the axial direction.

5. The drive device according to claim 1 or 2, wherein the axially extending positive locking regions of the radial webs engage in recesses of the housing.

6. The drive device according to claim 3, wherein the radial webs are part of a support element and protrude radially from a base body holding the motor shaft.

7. The drive device according to claim 6, wherein a bearing bush for holding the motor shaft is integrated in the base body of the support element.

8. The drive device according to claim 7, wherein the bearing bush is a part of the base body of the support element.

9. The drive device according to claim 7, wherein the bearing bush is inserted in one of a central opening and bore of the base body of the support element.

10. The drive device according to claim 9, wherein a free standing outer collar of the bearing bush adjoins an end face of the support element.

11. The drive device according to claim 1, wherein the support element is a part of the stator of the axial field motor.

12. The drive device according to claim 6, wherein a ring which is elastic at least in the axial direction is mounted between the radially aligned end ribs of the webs of the support element and the housing.

13. The drive device according to claim 1, wherein the motor shaft is connected to rotor discs which are mounted on two end faces of the stator.

14. The drive device according to claim 1, wherein the motor shaft is connected to a pinion of the gear mechanism which is designed as a spur wheel gear.

15. The drive device according to claim 14, wherein the spur wheel gear has a gear wheel of a first gear stage meshing with the pinion and connected coaxially to a second pinion of a second gear stage which meshes with a second gear wheel which is connected to the drive element of the adjusting device.

16. The drive device according to claim 12, wherein the housing comprises a twin-shell housing whose one housing shell is connected through the elastic ring to the radially directed end ribs of the radial webs of the support element.

17. The drive device according to claim 16, wherein the twin-shell housing holding the elastic ring has fixings through which the drive device is connectable to a holding device.

18. An adjusting device in motor vehicles, comprising:
a drive element,
a drive device comprising an axial field motor having a motor shaft and
a gear mechanism which is connected to the motor shaft and with a drive element of the adjusting device,
wherein radial forces stemming from the motor shaft are introduced into a housing of one of the drive device and the axial field motor through axially extending positive locking regions of radial webs.
